(19) United States
(12) Patent Application Publication
(10) Pub. No.: US 2009/0034103 A1
(43) Pub. Date: Feb. 5, 2009

(54) Solar Film Viewing Cell

(76) Inventor: Mark Margolis, Woodland Hills, CA (US)

Correspondence Address: Arent Fox LLP, 555 West Fifth Street, 48th Floor, Los Angeles, CA, 90013, US

(21) Appl. No.: 11/849,152

(22) Filed: Aug. 31, 2007

Related U.S. Application Data
(60) Provisional application No. 60/952,811, filed on Jul. 30, 2007.

(51) Int. Cl. G02B 7/00

(52) U.S. Cl. 359/892; 359/894

(57) ABSTRACT

A solar viewing filter comprising a paperboard tube, and a paperboard disc having an aperture and film extending across the aperture, the paperboard disc being arranged within the paperboard tube to enable a user to view a solar event through the film when looking into the paperboard tube.

### CROSS-REFERENCE TO RELATED APPLICATIONS

This application claims priority to U.S. provisional application Ser. No. 60/952,811, filed on Jul. 30, 2007, entitled “Solar Film Viewing Cell” the contents of which are incorporated herein by reference.

### BACKGROUND

1. Field

The present disclosure relates generally to solar viewing cells, and more particularly, to the manufacture and use of a solar viewing filter configured to be an inexpensive alternative to traditional solar viewing cells attached to magnification devices.

2. Background

Traditionally, people endeavoring to view a solar eclipse or similar planetary event with their standard magnification devices had to purchase an expensive solar viewing attachment or cell that would mount onto their magnification device. These expensive cells are generally comprised of costly raw materials, e.g., glass and metal or plastic casings. As such, there is a need in the art for a solar film viewing cell that is generally comprised of inexpensive raw materials, allowing the user to effectively take advantage of the planetary viewing experience without unnecessarily requiring such user to purchase an expensive component.

### SUMMARY

One aspect of a solar viewing filter is disclosed. A solar viewing filter, includes a paperboard tube, a paperboard disc having an aperture, the paperboard disc being connected to said paperboard tube, and a film in the aperture of said paperboard disc.

Another aspect of a solar viewing filter is disclosed. A solar viewing filter, includes a paperboard tube, means, located at an end of said paperboard tube, for creating an aperture, and means, located at said aperture means, for viewing solar or planetary subjects.

One aspect of a method for manufacturing a solar viewing filter is also disclosed. The method includes cutting a plurality of apertures on a sheet of paperboard and scoring said sheet of paperboard so as to facilitate folding in half, placing a solar viewing film over half of said plurality of apertures and affixing with adhesive, folding said sheet of paperboard at score so as to keep said solar viewing film in between two layers of said sheet of paperboard, cutting a plurality of discs from folded sheet of paperboard, wherein said cutting step comprises a die cut of larger diameter and concentric to said cutting aperture step, and placing at least one of said plurality of discs at one end of a paperboard tube.

These, as well as other objects, features and benefits will now become clear from a review of the following detailed description of illustrative embodiments and the accompanying drawings.

### DESCRIPTION OF DRAWINGS

Aspects of the present invention are illustrated by way of example, and not by way of limitation, in the accompanying drawings wherein:

FIG. 1 illustrates a perspective view of a solar viewing cell;

FIG. 2 illustrates a side elevational view of a solar viewing cell with a paperboard disc removed;

FIG. 3 illustrates a top elevational view of a paperboard disc;

FIGS. 4a and 4b illustrate a top elevational view of a paperboard sheet prior to manufacturing the paperboard discs.

### DETAILED DESCRIPTION

The detailed description set forth below in connection with the appended drawings are intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details.

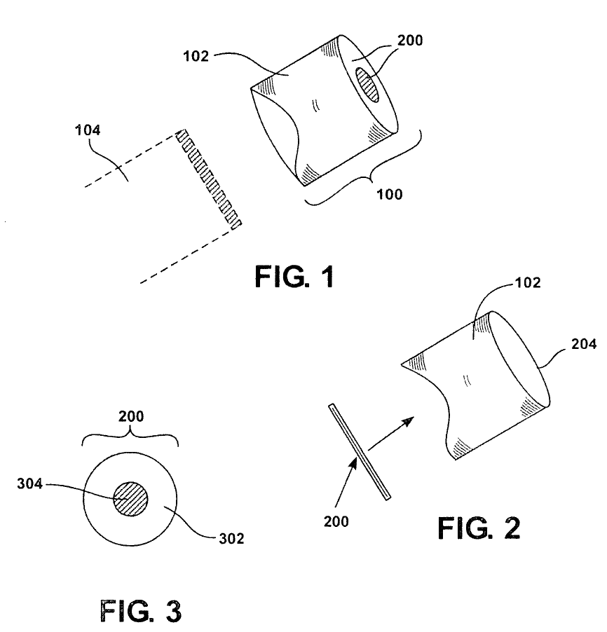

FIG. 1 illustrates a perspective view of a solar viewing cell. A solar viewing cell 100 may be manufactured from a paperboard tube 102 and a paperboard disc 200. Although the term “solar viewing cell” is used, one may appreciate that the disclosed apparatus may be used to view any solar or planetary event necessitating its use. As such, the terms solar viewing filter and solar viewing cell are used interchangeably. Also, as used herein, the term “cell” means any component, module, element, filter or piece that, due to its adaptability, may be placed over an underlying viewing device 104.

The viewing device 104 may be a pair of binoculars, a telescope, a camera or any other type of magnification or filming device. With the paperboard disc 200 sitting flush at the distal end of the paperboard tube 102, a user is able to slip the solar viewing cell 100 over the viewing device 104. Once the solar viewing cell 100 has been mounted over the viewing device 104, the solar viewing device 100 may be held to the viewing device 104 by friction fit, snap fit, adhesive, or other suitable means.

FIG. 2 illustrates a side elevational view of a solar viewing cell with a paperboard disc removed. The paperboard disc 200 may be a separate and distinct component from the paperboard tube 102, wherein the paperboard disc 200 provides a means for a solar viewing film extending across an aperture of the paperboard disc 200. The circumference of the paperboard disc 200 should be equal to the inner circumference of the paperboard tube 200. A curled edge 204 may be formed at the distal end of the paperboard tube 102 to hold the paperboard disc 200 in place during installation. By incorporating a curled edge 204 at the distal end of the paperboard tube 102, the paperboard disc 200 may attach snugly to the paperboard tube 102. This snug fit may be more effective by adding adhesive to the outer circumference of the paperboard disc 200 or creating a notch directly adjacent to the curled edge 204 so as to snap the paperboard disc 200 into place.

The paperboard tube 102 may be manufactured from a spiral paperboard core fabricated by winding paperboard plies spirally around a mandrel into a tube. In one embodiment of a solar viewing cell, the paperboard tube 102 will be at least one inch in length. This minimum length allows the user to slide the paperboard tube 102 onto the underlying viewing device 104 without the paperboard tube 102 easily coming loose.

FIG. 3 illustrates a top elevational view of a paperboard disc. The paperboard disc 200 may be comprised of a three-layer structure. The two outer layers may be identical paperboard portions 302 with concentric apertures of equal diameters. Between the paperboard portions 302 is a polyester or polymer substrate or film 304. The film 304 is atomized with a metal, such as chrome or aluminum, so as to give the film 304 its solar viewing properties, i.e., allows a user to use the film 304 to view a solar eclipse, or other solar or planetary event, without causing damage to the eye. Alternatively, the film 304 may also be comprised of an extruded polymer with a filtering material mixed into the substrate. The extruded polymer film may be comprised of a black polymer impregnated with filtering material. Once the paperboard disc 200 is manufactured, the paperboard disc 200 may be inserted through the opening at the proximal end of the paperboard tube 102 and then pushed towards the distal end of the paperboard tube 102.

An alternative embodiment of the above described three layer structure of a paperboard disc 200 is a paperboard disc having an “open back” construction. Under this type of construction, the paperboard disc 200 may have one outer layer with a single aperture. The film 304 may then be attached, via wet or dry adhesive, to the paperboard disc 200 so as to completely traverse the single aperture. This two layer structure may then be used in substantially the same manner as the three layer paperboard disc structure described, i.e., inserting into a paperboard tube 102 and pushed to the distal end of the paperboard tube 102 to facilitate mounting on a magnification device.

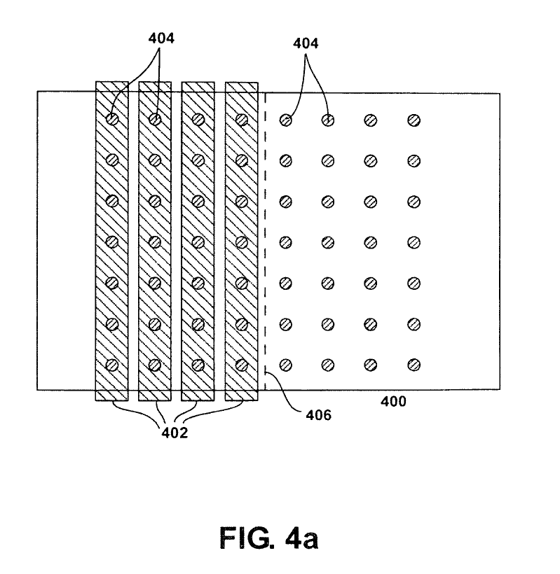

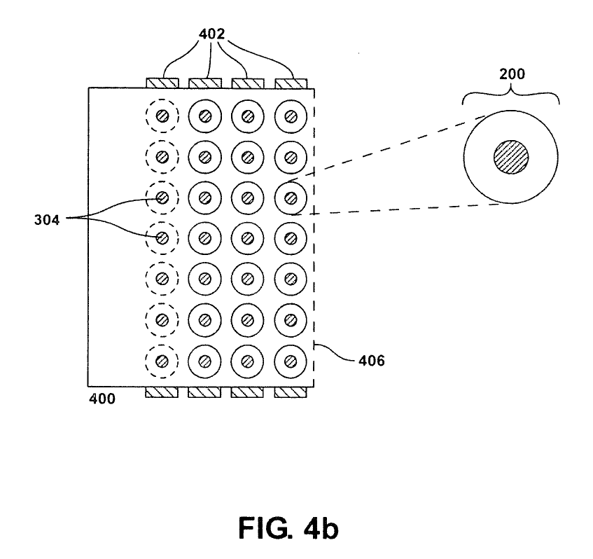

An example of a manufacturing process for a solar viewing cell will now be described in connection with FIGS. 4a and 4b. FIGS. 4a and 4b illustrate a top elevational view of a paperboard sheet prior to manufacturing the paperboard discs. The term paperboard means a paper-like material, usually over ten mils (0.010 inch) in thickness and is sometimes referred to interchangeably as craft paper, tag paper, posterboard, paste board, or fiber board. FIG. 4a illustrates a sheet of paperboard 400 with a score 406 at the halfway mark. The score 406 may be created by a die cut or other suitable means. The score 406 may facilitate the bending in half of the sheet of paperboard 400 and may ease the precise alignment of the series of apertures 404. The series of apertures 404 are created by the use of a die cutter. Each individual aperture 404 must have a corresponding aperture on the opposite side of the folded sheet of paperboard 400 so as to align when the sheet of paperboard 400 is folded. The series of apertures 404 may be cut with identical or different circumferences and/or uniformly spaced or not. Prior to folding the sheet of paperboard 400 over itself, however, a strip or sheet of film 402 is placed over each column of apertures 404 on one side of the paperboard sheet 400. In order to maintain the strips of film 402 over the apertures 404, a wet or dry adhesive may be used to prevent inadvertent movement of the strips of film 402.

FIG. 4b illustrates the sheet of paperboard 400 after having been folded over at the score 406 and contemporaneously keeping the strips of film 402 securely in place on the sheet of paperboard 400. One may use the same or different adhesive during the application of the strips of film 402 to the sheet of paperboard 400 in order to secure the folded over portion to the underlying sheet of paperboard 400. As illustrated, a second die cutting process may then be initiated so as to cut out a series of paperboard discs 200 comprising three layers of material as previously described.

While the specification describes particular embodiments of the present invention, those of ordinary skill can devise variations of the present invention without departing from the inventive concept. Also, the previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language of the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A solar viewing filter, comprising:
a paperboard tube; and
a paperboard disc having an aperture and film extending across the aperture, the paperboard disc being arranged within the paperboard tube to enable a user to view a solar event through the film when looking into the paperboard tube.

2. The solar viewing filter of claim 1 wherein said film comprises a polyester or polymer substrate with at least one layer of an atomized metal.

3. The solar viewing filter of claim 2 wherein said atomized metal comprises chrome or aluminum.

4. The solar viewing filter of claim 1 wherein said film comprises an extruded polymer with embedded filtering material.

5. The solar viewing filter of claim 4 wherein said filtering material comprises a black polymer with impregnated filtering properties.

6. The solar viewing filter of claim 1 wherein said paperboard tube comprises a spiral structure having a curled edge at one end of said paperboard tube.

7. The solar viewing filter of claim 4 wherein said paperboard disc abuts said curled edge of said paperboard tube.

8. The solar viewing filter of claim 1 wherein said paperboard tube comprises a length of at least one-half inch.

9. The solar viewing filter of claim 1 wherein said paperboard disc comprises a first and second paperboard layers, and a film layer between said first and second paperboard layers.

10. The solar viewing filter of claim 7 wherein said film is affixed to said first and third layers of said paperboard disc by adhesive.

11. The solar viewing filter of claim 1 wherein said paperboard disc comprises a single paperboard disc layer, and a film layer affixed to said single paperboard layer.

12. The solar viewing filter of claim 1 wherein said paperboard disc is connected to said paperboard tube by snap fit, adhesive, or friction fit.

13. A solar viewing filter, comprising:
a paperboard tube; and
a paperboard disc transversing the paperboard tube at one end, the paperboard disc having an aperture and a film extending across the aperture.

14. The solar viewing filter of claim 13 wherein said film comprises a polyester or polymer substrate with at least one layer of an atomized metal.

15. The solar viewing filter of claim 14 wherein said atomized metal comprises chrome or aluminum.

16. The solar viewing filter of claim 13 wherein said film comprises an extruded polymer with embedded filtering material.

17. The solar viewing filter of claim 16 wherein said filtering material comprises a black polymer with impregnated filtering properties.

18. The solar viewing filter of claim 13 wherein said paperboard tube comprises a spiral structure having a curled edge at one end of said paperboard tube.

19. The solar viewing filter of claim 18 wherein said paperboard disc abuts said curled edge of said paperboard tube.

20. The solar viewing filter of claim 13 wherein said paperboard tube comprises a length of at least one-half inch.

21. The solar viewing filter of claim 13 wherein said paperboard disc comprises a first and second paperboard layers, and a film layer between said first and second paperboard layers.

22. The solar viewing filter of claim 21 wherein said film is affixed to said first and third layers of said paperboard disc by adhesive.

23. The solar viewing filter of claim 13 wherein said paperboard disc comprises a single paperboard disc layer, and a film layer affixed to said single paperboard layer.

24. The solar viewing filter of claim 13 wherein said paperboard disc is connected to said paperboard tube by snap fit, adhesive, or friction fit

25. A solar viewing filter, comprising:
a paperboard tube; and
means for viewing solar or planetary events through the paperboard tube.

26. The solar viewing filter of claim 25 wherein said viewing means comprises a paperboard disc having an aperture, wherein said paperboard disc further comprises a film extending across said aperture.

27. The solar viewing filter of claim 26 wherein said film comprises a polyester or polymer substrate with at least one layer of an atomized metal.

28. The solar viewing filter of claim 27 wherein said atomized metal comprises chrome or aluminum.

29. The solar viewing filter of claim 25 wherein said film comprises an extruded polymer with embedded filtering material.

30. The solar viewing filter of claim 29 wherein said filtering material comprises a black polymer with impregnated filtering properties.

31. The solar viewing filter of claim 26 wherein said paperboard tube comprises means for affixing said viewing means at one end of said paperboard tube.

32. The solar viewing filter of claim 31 wherein said paperboard tube comprises means for sliding onto a viewing device.

33. The solar viewing filter of claim 31 wherein said viewing means is affixed to said viewing means by adhesive.

34. The solar viewing filter of claim 31 wherein said viewing means is connected to said paperboard tube by snap fit, adhesive, or friction fit.

35. A method for manufacturing a solar viewing cell, comprising:
cutting one or more apertures in a sheet of paperboard;
cutting a disc from a folded sheet of paperboard that is concentric with one of the apertures; and
placing the disc at one end of a paperboard tube.

36. The method of claim 35 further comprising scoring said sheet of paperboard so as to facilitate folding.

37. The method of claim 36 further comprising placing solar viewing film strips or sheets over each column of said plurality of apertures and adhering said solar viewing film to said sheet of paperboard.

38. The method of claim 37 further comprising folding said sheet of paperboard so that each of said apertures without solar viewing film overlie one of the apertures with solar viewing film and adhering said sheet of paperboard together.

39. The method of claim 38 wherein said solar viewing film comprises a polyester or polymer substrate with at least one layer of an atomized metal.

40. The method of claim 37 wherein said solar viewing film comprises an extruded black polymer substrate with impregnated filtering properties.

41. The method of claim 39 wherein placing the disc further comprises affixing said disc to said paperboard tube by friction fit or adhesive.
